(19) United States
(12) Patent Application Publication
(10) Pub. No.: US 2018/0088677 A1
(43) Pub. Date: Mar. 29, 2018

(54) PERFORMING OPERATIONS BASED ON GESTURES

(71) Applicant: Alibaba Group Holding Limited, George Town, KY (US)

(72) Inventors: Lei Zhang, Beijing (CN); Jun Peng, Hangzhou (CN)

(21) Appl. No.: 15/714,634

(22) Filed: Sep. 25, 2017

(30) Foreign Application Priority Data
Sep. 29, 2016 (CN) 201610866367.0

(51) Int. Cl. G06F 3/01; G06T 19/00; G06N 99/00

(52) U.S. Cl. CPC G06F 3/017; G06F 3/04815; G06N 99/005; G06T 19/006

(57) ABSTRACT

Gesture-based interaction includes displaying a first image, the first image comprising one or more of a virtual reality image, an augmented reality image, and a mixed reality image, obtaining a first gesture, obtaining a first operation based at least in part on the first gesture and a service scenario corresponding to the first image, the service scenario being a context in which the first gesture is input, and operating according to the first operation.

### CROSS REFERENCE TO OTHER APPLICATIONS

This application claims priority to People's Republic of China Patent Application No. 201610866367.0 entitled A GESTURE-BASED INTERACTION METHOD AND MEANS, filed Sep. 29, 2016, which is incorporated herein by reference for all purposes.

### FIELD OF THE INVENTION

The present application relates to a field of computer technology. In particular, the present application relates to a method, device, and system for gesture-based interaction.

### BACKGROUND OF THE INVENTION

Virtual reality (VR) technology is a computer simulation technology that makes possible the creation and experience of virtual worlds. VR technology uses computers to generate a simulated environment. VR technology is an interactive, three-dimensional, dynamic, visual and physical action system simulation that melds multiple information sources and causes users to become immersed in the (simulated) environment. According to the related art, VR technology is the combination of simulation technology with computer graphics human-machine interface technology, multimedia technology, sensing technology, network technology, and various other technologies. In some implementations, VR technology can, based on head rotations and eye, hand, or other body movements, employ computers to process data adapted to the movements of participants and produce real-time responses to user inputs.

Augmented reality (AR) technology uses computer technology to apply virtual information to the real world. AR technology superimposes the actual environment and virtual objects onto the same environment or space so that the actual environment and virtual objects exist simultaneously there.

Mixed reality (MR) technology includes augmented reality and virtual reality. Mixed reality refers to a new visualized environment generated by combining reality (e.g., real objects) with a virtual world (e.g., an environment comprising digital objects). In the new visualized environment, physical and virtual objects (i.e., digital objects) co-exist and interact in real time. According to an AR framework, virtual objects can be differentiated from the actual environment relatively easily. In contrast, according to a MR framework, physical and virtual objects, and physical and virtual environments are merged together.

In VR, AR, or MR technology, one application can have many service scenarios, and the same user gesture in different service scenarios can have different virtual operations requiring implementation. There is still no solution to the problem of how gesture-based interaction is achieved for multi-scenario applications.

### BRIEF DESCRIPTION OF THE DRAWINGS

Various embodiments of the invention are disclosed in the following detailed description and the accompanying drawings.

FIG. 1 is a functional structural block diagram of a system for gesture-based interaction according to various embodiments of the present application.

FIG. 2 is a flowchart of a method for gesture-based interaction according to various embodiments of the present application.

FIG. 3 is a flowchart of a method for gesture-based interaction according to various embodiments of the present application.

FIG. 4 is a flowchart of a method for gesture-based interaction according to various embodiments of the present application.

FIG. 5 is a flowchart of a method for gesture-based interaction according to various embodiments of the present application.

FIG. 6 is a functional diagram of a computer system for gesture-based interaction according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention can be practiced according to the claims without some or all of these specific details. For the purpose of clarity, technical material that is known in the technical fields related to the invention has not been described in detail so that the invention is not unnecessarily obscured.

As used herein, a terminal generally refers to a device used (e.g., by a user) within a network system and used to communicate with one or more servers. According to various embodiments of the present disclosure, a terminal includes components that support communication functionality. For example, a terminal can be a smart phone, a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a smart home appliance, vehicle-mounted mobile stations, or the like. A terminal can run various operating systems.

A terminal can have various input/output modules. For example, a terminal can have a touchscreen or other display, one or more sensors, a microphone via which sound input (e.g., speech of a user) can be input, a camera, a mouse, or other external input devices connected thereto, etc.

Various embodiments provide a gesture-based interactive method. The gesture-based interactive method can be applied in VR, AR, or MR applications with multiple implementations (e.g., service scenarios) or is suitable for similar applications having multiple implementations. The gesture-based interactive method can be implemented in various contexts (e.g., a sports-related application, a combat-related application, etc.). In some embodiments, a gesture is detected by a terminal and a command or instruction is provided to the VR, AR, or MR application based at least in part on the gesture. For example, a command or instruction can be generated in response to detecting the gesture and the command or instruction can be provided to the VR, AR, or MR application.

According to various embodiments, interaction models are set up to correspond to different service scenarios. The interaction models can be used in connection with determining corresponding operations based on gestures. The interactive models can comprise, or otherwise correspond to, mappings of gestures to commands. The interactive models can be stored locally at a terminal or remotely such as on a service. For example, the interactive models can be stored in a database. An interactive model can define a command to perform in the event of one or more gestures (e.g., a single gesture, or a combination of gestures) being obtained.

According to various embodiments, a terminal obtains a gesture using one or more sensors. The gesture can correspond to a gesture made by a user associated with the terminal. The sensors can include a camera, an imaging device, etc.

In the event that a terminal running a multi-scenario application obtains (e.g., acquires) a user's gesture, the interaction model corresponding to the service scenario in which the gesture is located can be used to determine the operation corresponding to the gesture under the service scenario and to execute that operation. The terminal can determine the application or scenario associated with the gesture (e.g., the context in which the gesture is made or otherwise input to the terminal), and can determine the operation corresponding to the gesture (e.g., based on mappings of operations to gestures for a particular service scenario or context). Thus, in the event of multiple service scenarios, the operation executed based on an obtained gesture (e.g., the user's gesture) is the application or scenario (e.g., service scenario) that matches the obtained gesture.

In some cases, a multi-scenario application has many service scenarios. It is possible to switch between the multiple service scenarios (e.g., within the multi-scenario application). For example, a sports-related virtual reality application comprises many sports scenarios: a table tennis two-person match scenario, a badminton two-person match scenario, etc. The user can select from among different sports scenarios and/or configurations (e.g., a one-person table tennis match scenario, a one-person badminton match scenario, etc.). As another example, a simulated combat virtual reality application comprises many combat scenarios: a pistol-shooting scenario, a close-quarters combat scenario, etc. In some embodiments, it is possible to switch between different combat scenarios in accordance with user choice and application settings. The desired scenario of the multi scenarios provided by the multi-scenario application can be selected based at least in part on an obtained gesture (e.g., a user's gesture).

In some cases, an application invokes another application. For example, a user or terminal can switch between multiple applications. As an example, one application can correspond to one service scenario. The desired application among a plurality of applications can be selected based at least in part on an obtained gesture (e.g., a user's gesture). In some embodiments, a gesture can correspond to a function for toggling between a plurality of applications (e.g., cycling through a defined sequence of a plurality of applications). In some embodiments, a gesture can correspond to a function for switching or selecting a specific application (e.g., a predefined application associated with the specific gesture that is obtained).

Service scenarios can be predefined, or the service scenarios can be set by the server. For example, in the case of a multi-scenario application, the scenario partitioning can be predefined in the configuration file of the application or in the application's code, or the scenario partitioning can be set by the server. Terminals can store information relating to scenarios partitioned by the server in the configuration file of the application. In some embodiments, partitions of service scenarios are predefined in the configuration file of the application or in the application's code. The server can repartition the application scenarios as necessary and send the information relating to the repartitioned service scenarios to the terminal, thus increasing the flexibility of multi-scenario applications. The scenario repartitioning can be predefined in the configuration file of the application or in the application's code, or the scenario partitioning can be set by the server. The scenario repartitioning can be performed by reversing the scenario partitioning that was performed on the multi-scenario application.

In some cases, the terminal that runs a multi-scenario application is any electronic device capable of running the multi-scenario application. The terminal can include a component configured to obtain (e.g., capture) gestures, a component configured to carry out response operations in relation to captured gestures based on service scenarios, a component configured to display information associated with various scenarios, etc. As an example of terminals running a virtual reality application, the components configured to obtain gestures can include infrared cameras or various kinds of sensors (e.g., optical sensors or accelerometers, etc.), and components configured to display (e.g., information) can display virtual reality scenario images, response operation results based on gestures, etc. The components configured to obtain gestures, the components configured for displaying information associated with various scenarios, components configured to carry out response operations in relation to captured gestures based on service scenarios and so on need not be integral parts of the terminal, but can instead be external components operatively connected to the terminal (e.g., via a wired or wireless connection).

(I) Correspondence of Interaction Models to Service Scenarios and Users

In some cases, the interaction model corresponding to a service scenario is suitable for all users that use that multi-scenario application. As an example, for all users (or one or more users) that use that multi-scenario application, in the event that response operations are carried out with regard to a gesture under the same service scenario, all of such users use the same interaction model to determine the operation corresponding to the gesture under that service scenario. The mappings of gestures to commands (or operations that are carried out in connection with a scenario) can be the same for a plurality of users. For example, a same gesture provided (e.g., input) by multiple users will cause the terminal to carry out the same operation in response to obtaining such gesture. In some embodiments, mappings of gestures to commands (or operations that are carried out in connection with a scenario) can be different for a plurality of users. For example, a same gesture provided (e.g., input) by multiple users will cause the terminal to carry out the different operations for different users in response to obtaining such same gesture. A user can configure the mappings of gestures to commands (or operations that are carried out in connection with a scenario).

In some cases, a plurality of users can be divided into user groups, with different user groups using different interaction models and the users in one user group using the same interaction model. The dividing of users into user groups can be used in connection with better matching the behavioral characteristics or habits of users (e.g., different users can find different correlations of gestures to commands to be natural or preferred). Users having the same or similar behavioral characteristics or habits can be assigned to a same user group. For example, users can be grouped according to user age. Generally, users of different ages, even when such users perform the same type of gesture, can cause differences in gesture recognition results owing to differences in their hand size and hand movements. The users can be grouped according to one or more other factors (e.g., characteristics associated with the users such as height and weight, etc.). Various embodiments of the present application impose no limits in this regard.

In some cases, a user registers with a service or application. For example, the user can register with the terminal on which the application is run, or the user can register with a server that provides a service (e.g., a service associated with a scenario). The user can obtain an identifier associated with the registration of the user. As an example, a user obtains a user account number (e.g., the user account number corresponding to the user ID) after registering. User registration information can include user age information. In some embodiments, a plurality of users are divided into different user groups based at least in part on the user age information (e.g., associated with the user registration information) such that different user groups correspond to different ages of users. User registration information can include location information (e.g., a geographic location), language information (e.g., associated with a preferred or native language), accessibility information (e.g., associated with specific accessibility requirements of the user), or the like. A plurality of users can be divided into user groups based at least in part on one or more of the aforementioned user registration information.

In some cases, before using a multi-scenario application, a user logs on (e.g., to the multi-scenario application or a service associated with the multi-scenario application that may be hosted by a server). The user logs on using the user account number. In response to a login request or to a successful login, it is possible to look up user-registered age information with the user account number and thus to determine the user group to which the user belongs. Thereupon, a response operation in relation to that user's gesture can be carried out on the basis of the interaction model corresponding to that user's group.

Table 1 presents the relationships between service scenarios, user groups, and interaction models. As provided in Table 1, different groups under the same service scenario correspond to different interaction models. Of course, it is also possible that the interaction models corresponding to different user groups are the same. Without loss of generality, for one user group, the interaction models used under different service scenarios generally differ. An interaction model can correspond to a set of mappings of one or more gestures to one or more commands (e.g., to run in response to the corresponding gesture being obtained).

TABLE 1

| Service scenario | User group | Interaction model |
|---|---|---|
| Service scenario 1 | User group 1 | Interaction model 1_1 |
| | User group 2 | Interaction model 1_2 |
| | . . . | . . . |
| Service scenario 2 | User group 1 | Interaction model 2_1 |
| | User group 2 | Interaction model 2_2 |
| | . . . | . . . |
| . . . | . . . | . . . |

In some cases, an interaction model corresponding to each user can be set up (e.g., defined). The setting up of an interaction corresponding to each user (or each subset of users) can be used in connection with better matching the behavioral characteristics or habits of users. In some embodiments, a user registers with a service or application. For example, the user can register with the terminal on which the application is run, or the user can register with a server that provides a service (e.g., a service associated with a scenario). The user can obtain an identifier associated with the registration of the user. As an example, a user obtains a user account number (e.g., the user account number corresponding to the user ID) after registering. Different user IDs correspond to different interaction models. In some embodiments, before using a multi-scenario application, a user logs on (e.g., to the multi-scenario application or a service associated with the multi-scenario application that can be hosted by a server). The user logs on using the user account number. In response to a login request or to a successful login, the user's ID can be searched (e.g., looked up) with the user account number (or the user account number corresponding to the user's ID can be searched), and thereupon to carry out a response operation in relation to that user's gesture on the basis of the interaction model corresponding to that user's ID.

Table 2 presents the relationships between service scenarios, user IDs, and interaction models. As provided in Table 2, different user IDs under the same service scenario correspond to different interaction models. Without loss of generality, the interaction models used under different service scenarios for the same user ID generally differ. An interaction model can correspond to a set of mappings of one or more gestures to one or more commands (e.g., to run in response to the corresponding gesture being obtained).

TABLE 2

| Service scenario | User ID | Interaction model |
|---|---|---|
| Service scenario 1 | User ID 1 | Interaction model 1_1 |
| | User ID 2 | Interaction model 1_2 |
| | . . . | . . . |
| Service scenario 2 | User ID 1 | Interaction model 2_1 |
| | User ID 2 | Interaction model 2_2 |
| | . . . | . . . |
| . . . | . . . | . . . |

(II) Interaction Model Input and Output

In some embodiments, interaction models define the correspondences between gestures and operations. The input data of the interaction model can include gesture data. The output data can include operation information (such as operation commands). As an example, the operation information can comprise one or more functions that are to be called (or operations to be performed) in response to associated input data being obtained. As another example, the operation information can correspond to one or more applications that are to be executed or to which the terminal is to switch in response to associated input data being obtained.

(III) Interaction Model Structure

In some cases, the interaction model includes a gesture classification model and mapping relationships between gesture types and operations. The gesture classification model can be used in connection with determining corresponding gesture types based on gestures (e.g., based on the one or more gestures that are obtained). The gesture classification model can be applicable to all users. It is also possible for each gesture classification model to be configured for a different user group or for each gesture classification model to be configured for a different user. Gesture classification models can be obtained through sample training or through learning about user gestures and gesture-based operations. For example, a user can be prompted to train the terminal or service (e.g., provided by a service) to associate one or more gestures with an operation in connection with defining the gesture classification model.

The gesture classification model, or a portion thereof, can be stored locally at the terminal or remotely at a server (e.g., a server with which the terminal is in communication and/or that provides a service to the terminal).

The mapping relationships between gesture types and operations generally remain unchanged so long as there is no need to update the service scenarios. It is possible to predefine the mapping relationships between gesture types and operations as is needed for different service scenarios. In some embodiments, a user can configure the mapping relationships between gesture types and operations. The mapping relationships between gesture types and operations can be set according to user preferences, user settings, or historical information associated with a user's input of gestures to the terminal.

(IV) Gesture Types and Operations Defined by Interaction Models

According to various embodiments, gesture types correspond to one or more gestures types. Gesture types can include single-hand gesture types, two-hand gesture types, a gesture using one or more fingers on one or more hands, a facial expression, a movement of one or more parts of a user's body, or the like.

A single-hand gesture type can include a gesture wherein the center of the palm of a single hand is oriented towards a VR object. For example, such a single-hand gesture type can include a gesture moving towards a VR object, a gesture moving away from a VR object, a gesture wherein the palm moves back and forth, a gesture wherein the palm moves parallel to and above the plane of the VR scenario image, etc.

A single-hand gesture type can include a gesture wherein the center of the palm of a single hand is oriented away from a VR object. For example, such a single-hand gesture type can include a gesture moving towards a VR object, a gesture moving away from a VR object, a gesture wherein the palm moves back and forth, a gesture wherein the palm moves parallel to and above the plane of the VR scenario image, etc.

A single-hand gesture type can include a gesture of a single hand clenched into a fist or with fingers brought together.

A single-hand gesture type can include a gesture of a single hand opening a fist or spreading fingers apart.

A single-hand gesture type can include a right-hand gesture.

A single-hand gesture type can include a left-hand gesture.

A two-handed gesture type can include a combination gesture wherein the center of a left-hand palm is oriented towards a VR object and a center of a right-hand palm is oriented away from a VR object.

A two-handed gesture type can include a combination gesture wherein a center of a right-hand palm is oriented towards a VR object and a center of a left-hand palm is oriented away from a VR object.

A two-handed gesture type can include a combination gesture wherein one or more fingers on a left-hand are spread apart and one finger of the right hand inputs a selection (e.g., by performing a predefined motion associated with the selection such as a virtual-click action).

A two-handed gesture type can include a gesture wherein a left hand and a right hand periodically cross over each other.

Various other single-hand gesture types and/or two-handed gesture types are possible.

Various mapping relationships between gesture types and operations are possible. Examples of one or more defined mapping relationships between gesture types and operations are provided below:

A gesture including a single hand opening a fist or spreading fingers apart can be mapped to an operation associated with opening a menu. For example, a menu associated with an application currently being operated (e.g., being executed or displayed on the display of the terminal) can be opened in response to input of such a single-hand gesture. As another example, a menu associated with an operating system or other application running in the background can be opened in response to input of such a single-hand gesture.

A gesture including a single hand clenched into a fist or with fingers brought together can be mapped to an operation associated with closing a menu. For example, a menu associated with an application currently being operated (e.g., being executed or displayed on the display of the terminal) can be closed in response to input of such a single-hand gesture.

A gesture including one finger of a single hand inputting a selection (e.g., by touching the terminal such as on a touchscreen) can be mapped to an operation associated with selecting a menu option in a menu (e.g., selecting an option in a menu or opening the menu at the next level down).

A combination gesture wherein the center of the right-hand palm is oriented towards a VR object and the center of the left-hand palm is oriented away from a VR object can be mapped to an operation associated with opening a menu and selecting the menu option selected by a finger.

The above are merely examples. In actual applications, mapping relationships between gesture types and operations can be defined as needed or otherwise desired.

(V) Methods of Configuring Interaction Models

Interaction models or gesture classification models can be configured or otherwise defined in advance. For example, an interaction model or gesture classification model can be set up in the installation package for an application and thus be stored in the terminal following installation of the application. As another example, a server can send an interaction model or gesture classification model to the terminal. A configuration method in which a server sends an interaction model or gesture classification model to the terminal is suitable for interaction models or gesture classification models applicable to all users (e.g., in contexts for which specific interaction models or gesture classification models are not needed for a specific user).

In some cases, an initial interaction model or gesture classification model can be predefined. In some embodiments, the predefined interaction model or gesture classification model is updated. For example, the predefined interaction model or gesture classification model can be updated or otherwise modified based at least in part on statistical information on gestures and on gesture-based operations. The updating or modification to the predefined interaction model or gesture classification model can be performed based on a self-learning process. The self-learning process use user usage data (e.g., of the application) in connection with the updating or modification to the predefined interaction model or gesture classification model. In some embodiments, the terminal can update the predefined interaction model or gesture classification model. In some embodiments, a server can update the predefined interaction model or gesture classification model. Accordingly, the interaction model or gesture classification model can be continually improved (e.g., optimized) on the basis of using historical information or statistical information to inform updates (e.g., by the terminal or server). The historical information or statistical information includes information associated with usage of an application, the terminal, and/or the gesture's input. This configuration method is suitable for interaction models or gesture classification models applicable to specific users.

In some cases, an initial interaction model or gesture classification model can be predefined. Subsequently, the terminal sends statistical information (or historical information) associated with gestures and gesture-based operations to a server. The server analyzes the statistical information and can update the interaction model or gesture classification model according to statistical information on gestures and on gesture-based operations. Information associated with the update to the interaction model or gesture classification model can be obtained by the terminal. For example, the server can send the updated interaction model or gesture classification model to the terminal. The updated interaction model or gesture classification model can be pushed to the terminal (or a plurality of terminals) in the event that the interaction model or gesture classification model is updated, and/or the interaction model or gesture classification model can be sent to the terminal according to a predefined period of time. Accordingly, the interaction model or gesture classification model is continually improved (e.g., optimized) for using historical information or statistical information to inform updates (e.g., by a learning approach). The historical information or statistical information includes information associated with usage of an application, the terminal, and/or the gestures input. This configuration method is suitable for interaction models or gesture classification models applicable to specific user groups or applicable to all users. Optionally, the server can employ a cloud-based operating system. As an example, the server can use and benefit from the cloud computing capabilities of the server. Of course, this configuration method is also suitable for interaction models or gesture classification models applicable to specific users. The server can store the updated interaction model and can communicate the updated interaction model to a terminal.

Detailed descriptions of embodiments of the present application are provided below in light of the drawings.

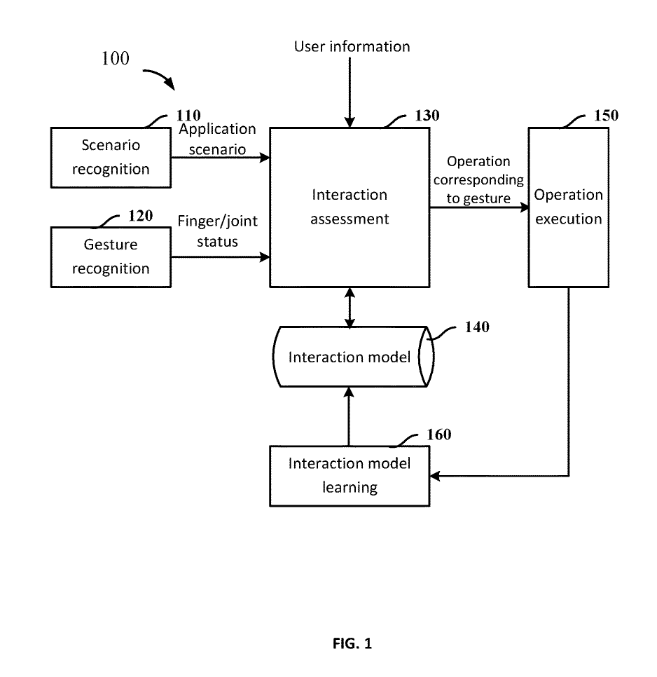

FIG. 1 is a functional structural block diagram of a system for gesture-based interaction according to various embodiments of the present application.

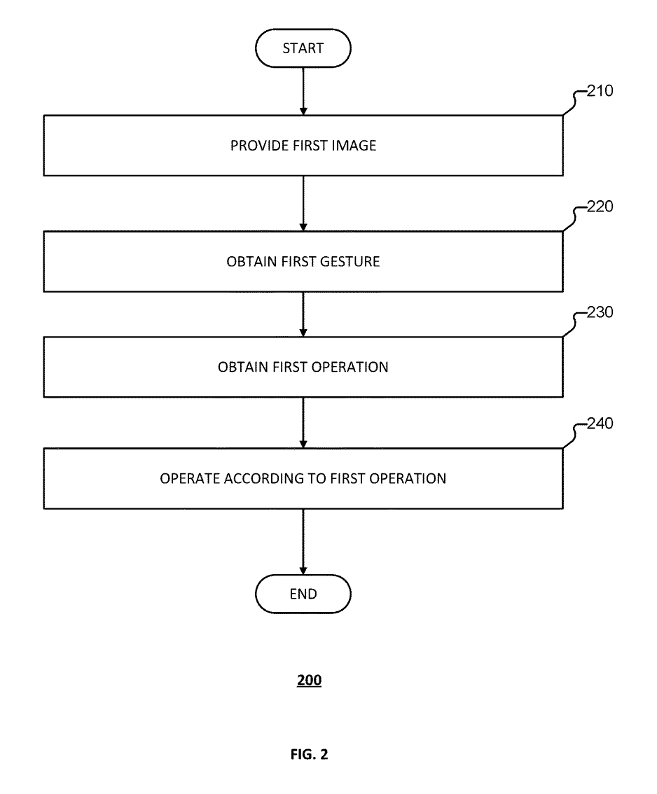

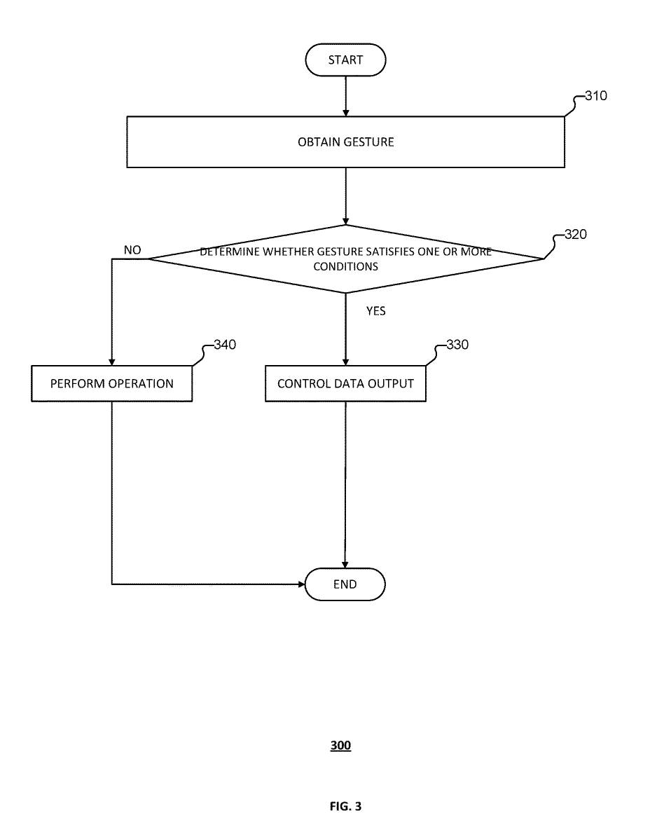

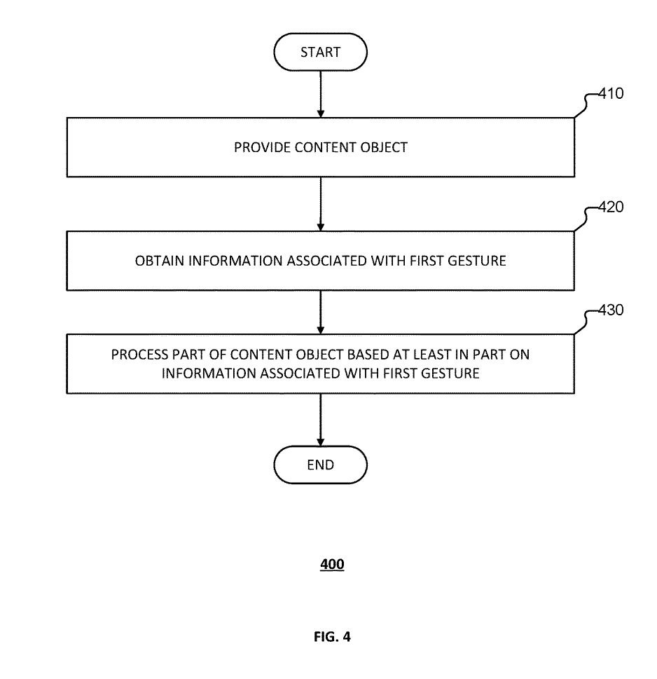

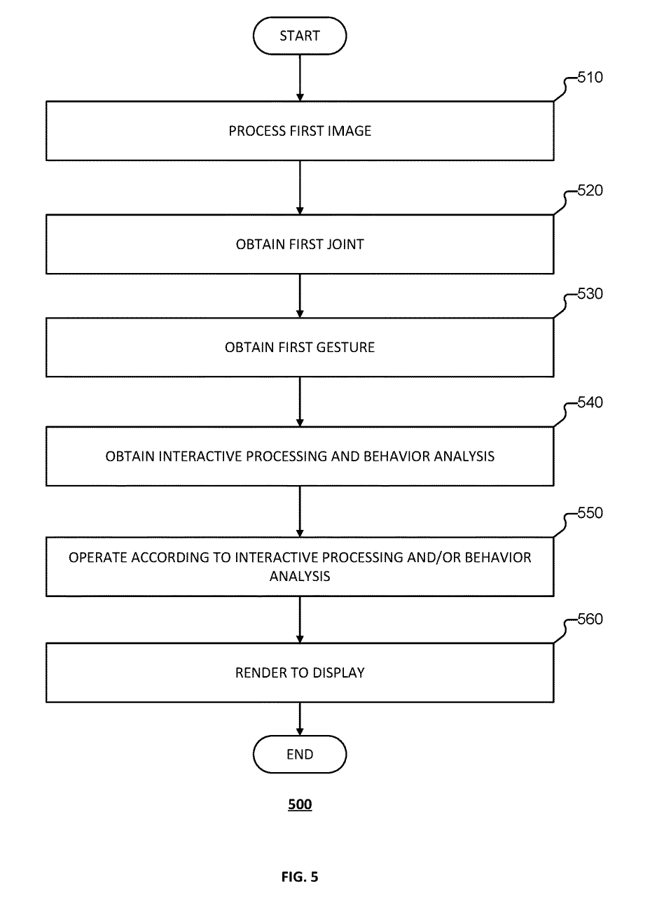

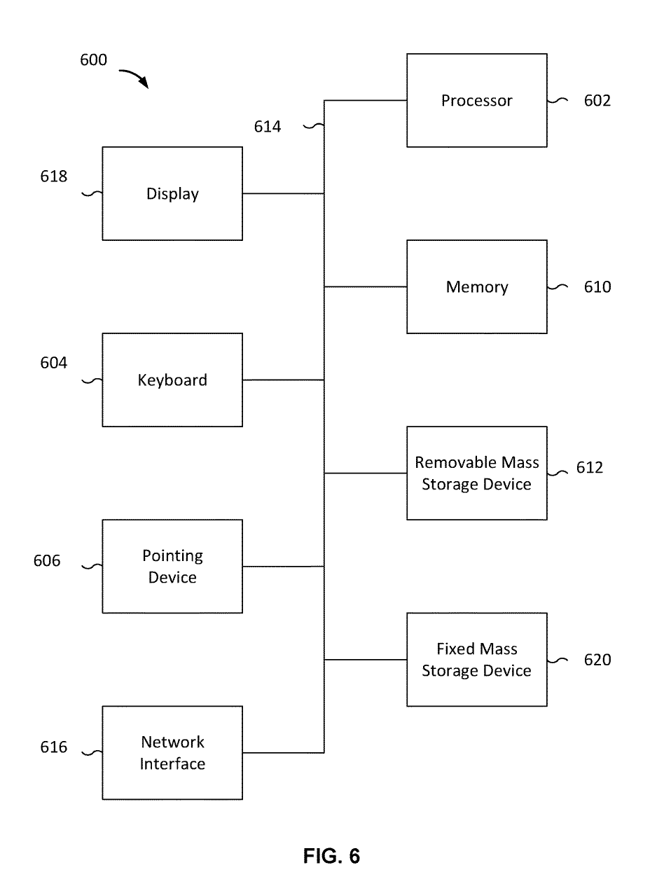

Referring to FIG. 1, system 100 for gesture-based interaction is provided. System 100 can implement all or a part of process 200 of FIG. 2, process 300 of FIG. 3, process 400 of FIG. 4, and/or process 500 of FIG. 5. System 100 can be implemented by computer system 600 of FIG. 6.

As illustrated in FIG. 1, system 100 can include one or more modules (e.g., units or devices) that perform one or more functions. For example, system 100 includes scenario recognition module 110, gesture recognition module 120, interaction assessment module 130, interaction model module 140, operation execution module 150, and interaction model learning module 160.

The scenario recognition module 110 is configured to recognize service scenarios. The recognition results obtained by scenario recognition module 110 can include information associated with a context of the terminal or server (e.g., an application running on the terminal or server, a user associated with or logged in to the terminal or server, etc.). The gesture recognition module 120 is configured to recognize user gestures. The recognition results obtained by the gesture recognition module 120 can include information associated with finger and/or finger joint statuses and movements. The interaction assessment module 130 determines an operation corresponding to the obtained gesture in connection with the obtained service scenario. For example, interaction assessment module 130 can use a recognized service scenario and a recognized gesture to determine the operation corresponding to the obtained gesture in connection with the obtained service scenario. Interaction model module 140 is configured to store interaction models (e.g., mappings of gestures and service scenarios). Interaction assessment module 130 can use the interaction models stored at interaction model module 140 as a basis for determining the operation corresponding to the obtained gesture in connection with the obtained service scenario. Interaction assessment module 130 can search mappings of gestures and service scenarios stored at interaction model module 140 for an operation associated with the obtained gesture and the obtained service scenario. The operation executing module 150 is configured to execute the operation determined by the interaction model. As an example, the operation executing module 150 can include one or more processors to execute instructions associated with the operation. The operation determined by the interaction model can include opening or switching to an application, obtaining or displaying a menu of the application, performing a specific function of an application or of the operating system of the terminal, etc. The interaction model learning module 160 is configured to analyze statistical information or historical information. For example, interaction model learning module 160 can analyze statistical information associated with operations executed by operation executing module 150. For example, interaction model learning module 160 can learn statistical information associated with operations executed by operation executing module 150 and improve or optimize the corresponding interaction model. Interaction model learning module 160 can update the corresponding interaction model stored at interaction model module 140.

The interaction model module 140 can be a storage medium. In some cases, the storage medium can be local to one or more of scenario recognition module 110, gesture recognition module 120, interaction assessment module 130, operation execution module 150, and interaction model learning module 160. For example, the storage medium can be local to a terminal comprising one or more of scenario recognition module 110, gesture recognition module 120, interaction assessment module 130, operation execution module 150, and interaction model learning module 160. In some cases, the storage medium can be remote in relation to one or more of scenario recognition module 110, gesture recognition module 120, interaction assessment module 130, operation execution module 150, and interaction model learning module 160. For example, the storage medium can be connected to one or more of scenario recognition module 110, gesture recognition module 120, interaction assessment module 130, operation execution module 150, and interaction model learning module 160 via a network (e.g., a wired network such as a LAN, a wireless network such an Internet or a WAN, etc.).

One or more of scenario recognition module 110, gesture recognition module 120, interaction assessment module 130, interaction model module 140, operation execution module 150, and interaction model learning module 160 can be implemented by one or more processors. The one or more processors can execute instructions in connection with performing the functions of one or more of scenario recognition module 110, gesture recognition module 120, interaction assessment module 130, interaction model module 140, operation execution module 150, and interaction model learning module 160. In some cases, one or more of scenario recognition module 110, gesture recognition module 120, interaction assessment module 130, interaction model module 140, operation execution module 150, and interaction model learning module 160 are at least partially implemented by, or connected to, one or more sensors such as a camera, etc. For example, the gesture recognition module 120 can obtain information associated with finger and/or finger joint statuses and movements from a camera or another sensor that is configured to detect a movement or position of an object such as a user.

In some embodiments, interaction assessment module 130 can use user information as a basis for determining the corresponding interaction model and/or can use the determined interaction model corresponding to the user information to determine the operation corresponding to the appropriate user's gesture under the recognized service scenario.

FIG. 2 is a flowchart of a method for gesture-based interaction according to various embodiments of the present application.

Referring to FIG. 2, process 200 for gesture-based interaction is provided. All or part of process 200 can be implemented by system 100 of FIG. 1 and/or computer system 600 of FIG. 6. Process 200 can be implemented by a terminal. Process 200 can be invoked in the event that a corresponding multi-scenario application starts up. For example, in response to a multi-scenario application is selected to run, process 200 can be performed.

At 210, a first image is provided. For example, a first image can be displayed by a terminal. The first image can be displayed when (e.g., in response to) a corresponding multi-scenario application being start up. In some embodiments, the first image comprises one or a combination of more than one of a virtual reality image, an augmented reality image, and a mixed reality image. The first image can be displayed using a display of the terminal or operatively connected to the terminal (e.g., a touch screen, a headset connected to the terminal, etc.). The first image can be displayed in connection with an application being executed by a terminal. In some embodiments, the first image is sent by a server to a terminal for display. The first image can correspond to, or comprise, a plurality of images such as a video. The first image can be stored locally at the terminal. The first image can be stored on the terminal in association with the corresponding multi-scenario application. In some embodiments, the first image is generated by the terminal. In some embodiments, the terminal can obtain the first image from a remote repository (e.g., from a server).

At 220, a first gesture of a user is obtained. One or more sensors can be used in connection with obtaining the first gesture. For example, one or more sensors can include a camera configured to capture images, an infrared camera configured to capture images, a microphone configured to capture sounds, a touchscreen configured to capture information associated with a touch, etc. The one or more sensors can be part of or connected to the terminal. The terminal can obtain information from the one or more sensors and can aggregate, or otherwise combine, the information obtained from the one or more sensors to obtain the first gesture. For example, the terminal can determine the first gesture based at least in part on information obtained from the one or more sensors.

In some embodiments, multiple modes of capturing user gestures are provided. For example, an infrared camera can be used to capture images, and the user's gesture can be obtained by performing gesture recognition on the captured images. Accordingly, capturing barehanded gestures is possible.

The information obtained by the one or more sensors can include noise or other distortion. In some embodiments, the information obtained by the one or more sensors can be processed to eliminate or reduce such noise or other distortion. The processing of the information obtained by the one or more sensors can include one or more of image enhancement, image binarization, grayscale conversion, noise elimination, etc. Other preprocessing technologies can be implemented.

For example, in order to improve the precision of gesture recognition, the images captured by the infrared camera can be preprocessed to eliminate noise.

As an example, an image enhancement processing can be performed on the images. If external lighting is insufficient or too intense, brightness enhancement can be used to improve the captured image. Image enhancement can improve gesture detection and recognition precision. Specifically, brightness parameter detection can be performed. The brightness parameter detection can include calculating the mean Y value of the video frame, and using a threshold value T. If Y>T, brightness is determined to be excessive. Otherwise, if Y≦T, then the image captured is deemed to be sufficiently dim. In some embodiments, a non-linear algorithm is used to calculate Y enhancement. For example, Y enhancement can be calculated according to Y′=Y*a+b, where a corresponds to a weight value and b is an offset value.

As an example, image binarization processing can be performed on the images. Image binarization refers to setting the grayscale values of pixel points on an image to 0 or 255. For example, the image is processed using binarization such that the image as a whole exhibits an obvious black-and-white effect.

As an example, grayscale image conversion processing can be performed on the images. In an RGB (Red-Green-Blue) model, if R=G=B, then color is expressed as a grayscale color, wherein the value of R=G=B is called a grayscale value. Therefore, each pixel of a grayscale image needs only one byte to store a grayscale value (also called intensity value or brightness value). The range of grayscale values is from 0 to 255.

As an example, noise elimination processing can be performed on the images. Noise elimination can include eliminating (or reducing) noise points from an image.

In some embodiments, gesture precision requirements and performance requirements (such as response speed) can serve as a basis for determining whether to perform image preprocessing or for determining the image processing method that is to be used.

The first gesture can be determined based at least in part on information obtained from the one or more sensors. For example, a mapping of gestures and characteristics of information obtained from one or more sensors can be stored, such that a look up can be performed to obtain the gesture corresponding to the information obtained from the one or more sensors. The gesture corresponding to the first image can be obtained.

During gesture recognition, the gesture can be recognized using a gesture classification model. When a gesture is recognized using a gesture classification model, the input parameters for the model can be images captured with an infrared camera (or preprocessed images), and the output parameters can be gesture types. The gesture classification model can be obtained using a learning approach based on a support vector machine (SVM), a convolutional neural network (CNN), a DL, or any other appropriate approach. The gesture classification model can be stored locally at the terminal or remotely at a server. In the event that the gesture classification model is stored remotely at the server, the terminal can send information associated with the first image to the server and the server can use the gesture classification model to determine the first gesture (or associated gesture type), or the terminal can obtain information associated with the gesture classification model to allow for the terminal to determine the first gesture (or associated gesture type).

Various embodiments support various types of gestures, such as finger-bending gestures. Accordingly, joint recognition can be performed in order to recognize this type of gesture. Detecting finger joint status based on joint recognition is possible and thus the corresponding type of gesture can be determined. Examples of joint recognition techniques include the Kinect algorithm and other appropriate algorithms. In some embodiments, hand modeling can be used to obtain joint information with which joint recognition is performed.

At 230, a first operation is obtained. For example, a first operation can be determined based at least in part on the first gesture. The obtaining of the first operation can comprise the terminal or the server determining the first operation. In some embodiments, the first operation is determined based at least on the first gesture and a service scenario corresponding to the first image. The first operation can be obtained by performing a look up against a mapping of gestures and service scenarios to find the first operation that corresponds to the first gesture in the context of the service scenario corresponding to the first image. The first operation can correspond to a single operation or a combination of two or more operations. In some embodiments, a multi-scenario application includes a plurality of service scenarios, and the first image is associated with at least one of the plurality of service scenarios. The service scenario corresponding to the first image can be obtained by performing a look up against a mapping of gestures and service scenarios to find the service scenario corresponding to the first image. According to some embodiments, in the event that an image is associated with a plurality of service scenarios, the service scenario corresponding to the first image can be obtained by performing a look up against a mapping of gestures, images, and the first image.

At 240, operating a device according to the first operation is performed. In some embodiments, the terminal operates according to the first operation. For example, the terminal can perform the first operation.

In some embodiments, the first operation corresponds to a user interface operation. For example, the first operation can be a menu operation (e.g., opening a menu, closing a menu, opening a sub-menu of the current menu, selecting a menu option from the current menu, or other such operation). Accordingly, in connection with performing a menu operation, various operations can be performed, including opening a menu, rendering a menu, and displaying the menu to the user. In some embodiments, the menu is displayed to the user using a VR display component. In some embodiments, the menu is displayed to the user using an AR or MR display component.

According to various embodiments, the first operation is not limited to menu operations. Various other operations can be performed (e.g., opening an application, switching to an application, obtaining specific information from the internet or a web service, etc.). For example, the first operation can be another operation, such as a speech prompt operation.

According to various embodiments, in the event there are multiple service scenarios, the operation executed on the basis of a gesture is made (e.g., selected) to match the current service scenario.

Process 200 can further include obtaining an interaction model corresponding to the service scenario. For example, the interaction model can be acquired based at least in part on the service scenario in which the first gesture is obtained. The interaction model can be obtained before 230 is performed. In some embodiments, at 230, the interaction model corresponding to the service scenario is used according to a first gesture to determine the first operation corresponding to the first gesture under the service scenario.

According to various embodiments, the interaction model includes a gesture classification model and mapping relationships between gesture types and operations. In some embodiments, at 230, the gesture classification model corresponding to the service scenario is used according to a first gesture to determine the gesture type associated with the first gesture under the service scenario. For example, the gesture type associated with the first gesture and the mapping relationship serve as a basis for determining the first operation corresponding to the first gesture under the service scenario.

In the event that different user groups are provided with a corresponding interaction model or gesture classification model (e.g., in the event that not all user groups have identical corresponding interaction models or gesture classification models), it is possible to acquire information on the user that made the first gesture, to use such user information in connection with determining the user group to which the user belongs, and to acquire the gesture classification model corresponding to the user group. In some embodiments, the user group information and the user information (e.g., age of the user, location of the user, etc.) for the user can serve as a basis for determining the user group to which the user belongs and for acquiring the gesture classification model corresponding to the user group to which the user belongs.

In some embodiments, two users have different interaction models and/or gesture classification models. For example, each user can have an interaction model or a gesture classification model specifically associated with such user. In the event that at least two users are provided with different corresponding interaction models and/or gesture classification models, a gesture classification model corresponding to the user can be obtained based at least in part on an ID associated with the user. For example, a user ID associated with the user can be obtained, and the obtained user ID can be used in connection with obtaining, or otherwise determining, the corresponding gesture classification model. The user ID can be input by a user in connection with a login to a terminal, etc. The user ID can be generated in connection with a registration of an application (e.g., a multi-service application). For example, the user ID can be generated or determined by a user in connection with a user's registration of the application.

In some embodiments, interaction models and/or gesture models can be determined, or otherwise obtained, based at least in part on historical information or statistical information. For example, the interaction models and/or gesture models can be obtained based at least in part on learning (e.g., offline learning based on the terminal performing a training operation or process, or an analysis of usage of the terminal). As an example, a gesture classification model could be trained with gesture samples, and a server could send the trained gesture classification model to the terminal, and use the result to adjust the model's parameters to tune the model. As another example, a terminal could provide a gesture classification model training function. After a user chooses to enter the gesture classification model training mode, the user could make various gestures to obtain corresponding operations and evaluate the response operations, thus continually correcting the gesture classification model. In some embodiments, the user can configure the interaction models and/or gesture models based on user preferences, user settings, and/or user historical (e.g., usage) information.

In some embodiments, the interaction model or gesture classification model is updated (e.g., improved or optimized) online. For example, the terminal could conduct interaction model or gesture classification model online learning based on collected gestures and operations in response to gestures. The terminal can send the information associated with the gestures and the operations executed on the basis of the gestures to the server. The server can analyze the information associated with the gestures and the operations executed on the basis of the gestures. Based on the analysis of the information associated with the gestures and the operations executed on the basis of the gestures, the server can update the interaction model or gesture classification model. As an example, the server can correct the interaction model or gesture classification model and send the corrected interaction model or gesture classification model to the terminal.

According to various embodiments, after 240 of process 200 of FIG. 2, process 200 can include performing a learning (e.g., updating) of the interaction model or the gesture classification model. For example, after 240, the terminal can obtain a second operation executed on the basis of a second gesture after the first gesture under the service scenario and the terminal can update the gesture classification model according to the relationship between the second operation and the first operation. The terminal can assess, based at least in part on the second operation following the first operation, whether the first operation is the operation expected by the user. For example, the terminal can deem that the user intended for the terminal to perform the second operation in response to the first gesture (e.g., in the event that the user subsequently causes the second operation to be performed after the first operation is performed based at least in part on the first gesture). If the terminal determines that the first operation does not correspond to the operation expected by the user, then the gesture classification model can be deemed insufficiently precise and requires updating.

The gesture classification model can be updated according to various relationships between the second operation and the first operation. For example, updating the gesture classification model based on the relationship between the second operation and the first operation can include one of, or any combination of, the operations below:

If the target object of the first operation is the same as the target object of the second operation, and if the operation actions are different, then update the gesture type associated with the first gesture in the gesture classification model. For example, if the first operation is the operation of opening a first menu, and the second operation is the operation of closing the first menu, it can be deemed that the user did not wish to open the menu in response to the first gesture. In other words, the recognition of the gesture requires increased precision. Therefore, the gesture classification associated with the first gesture in the gesture classification model can be updated (e.g., to reflect the user's intention when inputting the first gesture).

If the target object of the second operation is a sub-target of the target object of the first operation, then the gesture type associated with the first gesture in the gesture classification model can be kept unchanged. For example, if the first operation is the operation of opening a second menu, and the second operation is the operation of selecting a menu option from the second menu, then the gesture type associated with the first gesture in the gesture classification model is kept unchanged. In some embodiments, the target object of the first operation can be updated to the target object of the second operation. For example, even if the target object of the second operation is a sub-target of the target object of the first operation, if the terminal determines (e.g., from analysis of historical or usage information) that the second gesture is consistently input to select the target object of the second operation sequentially after the first gesture is input, then it could be determined that the mapping of the first gesture corresponding to the first operation should be updated to map the first gesture (or otherwise a single gesture) to the second operation.

Furthermore, during interaction model or gesture classification model learning for one user group in situations in which each different user group is provided with an interaction model or gesture classification model (or at least two different user group is provided with differing interaction models or gesture classification models), the interactive operation information of users in that user group is used for training or learning of the interaction model or gesture classification model corresponding to that user group. During interaction model or gesture classification model learning for one user in situations in which each different user is provided with an interaction model or gesture classification model, the interactive operation information for that user is used for training or learning of the interaction model or gesture classification model corresponding to that user.

FIG. 3 is a flowchart of a method for gesture-based interaction according to various embodiments of the present application.

Referring to FIG. 3, process 300 for gesture-based interaction is provided. All or part of process 300 can be implemented by system 100 of FIG. 1 and/or computer system 600 of FIG. 6. Process 300 can be implemented by a terminal. All or part of 300 can be performed in connection with process 200 of FIG. 2 and/or process 500 of FIG. 5. Process 300 can be invoked in the event that a corresponding multi-scenario application starts up. For example, in response to a multi-scenario application is selected to run, process 300 can be performed.

At 310, a gesture (e.g., a first gesture) is obtained. One or more sensors can be used in connection with obtaining the first gesture. For example, one or more sensors can include a camera configured to capture images, an infrared camera configured to capture images, a microphone configured to capture sounds, a touchscreen configured to capture information associated with a touch, etc. The one or more sensors can be part of or connected to the terminal. The terminal can obtain information from the one or more sensors and can aggregate, or otherwise combine, the information obtained from the one or more sensors to obtain the first gesture. For example, the terminal can determine the first gesture based at least in part on information obtained from the one or more sensors.

The first gesture can be obtained under, or otherwise in connection with, a VR scenario, an AR scenario, or an MR scenario.

At 320, it is determined whether the first gesture satisfies one or more conditions. In some embodiments, the terminal determines whether the first gesture satisfies the one or more conditions. The one or more conditions can be associated with parameters for defined gestures mapped to operations. In some embodiments, the server determines whether the first gesture satisfies the one or more conditions. For example, the terminal can send information associated with the first gesture to the server, and the server can use such information obtained from the terminal in connection with determining whether the first gesture satisfies the one or more conditions. The one or more conditions can be stored locally at the terminal or at a remote storage operatively connected to the terminal or server, or comprised in the server.

According to various embodiments, the one or more conditions (e.g., trigger condition) are predefined or set by a server. The data output-controlling operations corresponding to different trigger conditions can differ. The one or more conditions can be associated with parameters that define one or more gestures mapped to an operation according to a defined interactive model.

In some embodiments, after determining that the first gesture satisfies the one or more conditions (e.g., a trigger condition), the correspondence between the trigger condition and the data output-controlling operation is obtained. For example, in the event that the first gesture is obtained and determined to satisfy one or more conditions, the first operation can be determined. The data output-controlling operation corresponding to the trigger condition that is currently satisfied by the first gesture is determined on the basis of this correspondence.

In the event that it is determined that the first gesture satisfies the one or more conditions, process 300 proceeds to 330 at which data output is controlled. For example, the terminal can operate to control data output. The data output that is controlled comprises one or a combination of audio data, image data, and video data.

In some embodiments, the image data comprises one or more of virtual reality images, augmented reality images, and mixed reality images, and the audio data comprises audio corresponding to the current scenario. In some embodiments, one or more of audio data, image data, and video data comprise a virtual reality component, an augmented reality component, and/or a mixed reality component.

In the event that it is determined that the first gesture does not satisfy the one or more conditions at 320, then process 300 proceeds to 340 at which an operation is performed. For example, the terminal can perform a response or another operation based on the first gesture.

As an example in the context of a virtual reality scenario, if the user makes the movement of pushing a door in a dark night scenario, then the sound of a door latch opening is emitted at 330. With regard to this application, if the user's gesture is captured in the current dark night scenario, the gesture's magnitude or force is assessed according to gesture-related information to determine that a certain threshold value was exceeded (meaning that the main door can be opened only with relatively strong force). Thus, the sound of the main door opening is emitted. Furthermore, the volume, timbre, or duration of the emitted sound varies according to the magnitude or force of the gesture.

FIG. 4 is a flowchart of a method for gesture-based interaction according to various embodiments of the present application.

Referring to FIG. 4, process 400 for gesture-based interaction is provided. All or part of process 400 can be implemented by system 100 of FIG. 1 and/or computer system 600 of FIG. 6. Process 400 can be implemented by a terminal. All or part of 400 can be performed in connection with process 200 of FIG. 2, process 300 of FIG. 3, and/or process 500 of FIG. 5. Process 400 can be invoked in the event that a corresponding multi-scenario application starts up. For example, in response to a multi-scenario application is selected to run, process 400 can be performed.

At 410, a content object is provided. In some embodiments, the content object comprises a first image. The first image can comprise a first object and a second object. In some embodiments, at least one of the first object and the second object is a virtual reality object, an augmented reality object, or a mixed reality object. The content object can be displayed on a screen of the terminal, or on a display operatively connected to the terminal.

At 420, information associated with a first gesture is obtained. For example, the information associated with a first gesture can be obtained from one or more sensors used in connection with detecting the first gesture. In some embodiments, the information associated with first gesture signal is associated with the first object.

One or more sensors can be used in connection with obtaining the first gesture. For example, one or more sensors can include a camera configured to capture images, an infrared camera configured to capture images, a microphone configured to capture sounds, a touchscreen configured to capture information associated with a touch, etc. The one or more sensors can be part of or connected to the terminal. The terminal can obtain information from the one or more sensors and can aggregate, or otherwise combine, the information obtained from the one or more sensors to obtain the first gesture. For example, the terminal can determine the first gesture based at least in part on information obtained from the one or more sensors.

At 430, at least a part of the content object is processed. The part of the content object is processed based at least in part on the information associated with the first gesture. For example, the first operation corresponding to the first gesture is used as a basis for processing the second object.

In some embodiments, the service scenario in which the first gesture is located is used as a basis for obtaining an interaction model corresponding to the service scenario. The interaction model can be used in connection with determining a corresponding operation based on the gesture. Then, based at least in part on the first gesture, the interaction model corresponding to the service scenario is used in connection with determining the first operation corresponding to the first gesture under the service scenario. Various methods for determining operations corresponding to gestures (e.g., in connection with interaction models) can be used. Examples of interaction models and interaction model-based methods for determining operations corresponding to gestures are described above.

In some embodiments, the relationships between gestures and objects are preset. For example, the relationships between gestures and objects can be set in configuration files or program coding or set by a server.

To give the example of a simulated fruit-cutting VR application, the user gesture is associated with a “paring knife.” The “paring knife” therein is a virtual object. When running such a VR application, the terminal can use the captured and recognized user gesture as a basis for displaying a “paring knife” in the VR application interface. Moreover, the “paring knife” can move in tandem with the user gesture so as to generate the visual effect of cutting fruit in the interface. In a specific implementation, an initial tableau is first displayed at 410. The “paring knife” is displayed in this tableau as a first object, and various kinds of fruit are displayed in this tableau as a “second object.” Both the paring knife and the fruit are virtual reality objects. At 420, the user grabs the paring knife and brandishes the paring knife, performing a fruit-cutting action. The terminal can obtain the user's gesture and, on the basis of the mapping relationship between the gesture and the object, determine that this gesture is associated with the paring knife, which is the “first object.” At 430, the terminal uses the motion track, speed, force, and other such information as a basis for performing cutting and other such result processing on the fruit, which is the “second object.”

FIG. 5 is a flowchart of a method for gesture-based interaction according to various embodiments of the present application.

Referring to FIG. 5, process 500 for gesture-based interaction is provided. All or part of process 500 can be implemented by system 100 of FIG. 1 and/or computer system 600 of FIG. 6. Process 500 can be implemented by a terminal. All or part of 500 can be performed in connection with process 200 of FIG. 2, process 300 of FIG. 3, and/or process 400 of FIG. 4. Process 500 can be invoked in the event that a corresponding multi-scenario application starts up. For example, in response to a multi-scenario application is selected to run, process 400 can be performed.

At 510, a first image is processed. Processing the image can include a pre-processing of the first image before the first image is provided (e.g., displayed). The preprocessing of the first image can include an image enhancement, an infrared binarization, etc. In some embodiments, pre-processing of the first image is performed based on whether a quality of the first image is sufficient. For example, if a quality of the first image is below one or more thresholds, pre-processing can be performed. The quality of the first image can be determined to be below the one or more thresholds based on a comparison of a measure of one or more characteristics to one or more thresholds associated with the one or more characteristics. The first image can be provided after pre-processing is completed, or if pre-processing is determined to not be necessary. For example, a first image can be displayed by a terminal. The first image can be displayed when (e.g., in response to) a corresponding multi-scenario application being start up. In some embodiments, the first image comprises one or a combination of more than one of a virtual reality image, an augmented reality image, and a mixed reality image. The first image can be displayed using a display of the terminal or operatively connected to the terminal (e.g., a touch screen, a headset connected to the terminal, etc.). The first image can be displayed in connection with an application being executed by a terminal. In some embodiments, the first image is sent by a server to a terminal for display. The first image can correspond to, or comprise, a plurality of images such as a video. The first image can be stored locally at the terminal. The first image can be stored on the terminal in association with the corresponding multi-scenario application. In some embodiments, the first image is generated by the terminal. In some embodiments, the terminal can obtain the first image from a remote repository (e.g., from a server). The first image can be pre-processed using one or more preprocessing technologies.

At 520, a first joint of a user is obtained. One or more sensors can be used in connection with obtaining the first joint. For example, one or more sensors can include a camera configured to capture images, an infrared camera configured to capture images, a microphone configured to capture sounds, a touchscreen configured to capture information associated with a touch, etc. The one or more sensors can be part of or connected to the terminal. The terminal can obtain information from the one or more sensors and can aggregate, or otherwise combine, the information obtained from the one or more sensors to obtain the first joint. For example, the terminal can determine the first joint based at least in part on information obtained from the one or more sensors.

Joint recognition can be performed in order to recognize certain types of gestures. For example, detecting finger joint status based on joint recognition is possible and thus the corresponding type of gesture can be determined. Examples of joint recognition techniques include the Kinect algorithm and other appropriate algorithms. In some embodiments, hand modeling can be used to obtain joint information with which joint recognition is performed.

In some embodiments, multiple modes of capturing user joint(s) are provided. For example, an infrared camera can be used to capture images, and the user's joint can be obtained by performing gesture recognition on the captured images. Accordingly, capturing barehanded joints is possible.

The information obtained by the one or more sensors can include noise or other distortion. In some embodiments, the information obtained by the one or more sensors can be processed to eliminate or reduce such noise or other distortion. The processing of the information obtained by the one or more sensors can include one or more of image enhancement, image binarization, grayscale conversion, noise elimination, etc. Other preprocessing technologies can be implemented.

At 530, a first gesture of a user is obtained. One or more sensors can be used in connection with obtaining the first gesture. For example, one or more sensors can include a camera configured to capture images, an infrared camera configured to capture images, a microphone configured to capture sounds, a touchscreen configured to capture information associated with a touch, etc. The one or more sensors can be part of or connected to the terminal. The terminal can obtain information from the one or more sensors and can aggregate, or otherwise combine, the information obtained from the one or more sensors to obtain the first gesture. For example, the terminal can determine the first gesture based at least in part on information obtained from the one or more sensors. The first gesture can be obtained based at least in part on the obtaining of the first gesture. For example, the first gesture can be obtained if the first join is obtained (e.g., determined).

In some embodiments, multiple modes of capturing user gestures are provided. For example, an infrared camera can be used to capture images, and the user's gesture can be obtained by performing gesture recognition on the captured images. Accordingly, capturing barehanded gestures is possible.

The information obtained by the one or more sensors can include noise or other distortion. In some embodiments, the information obtained by the one or more sensors can be processed to eliminate or reduce such noise or other distortion. The processing of the information obtained by the one or more sensors can include one or more of image enhancement, image binarization, grayscale conversion, noise elimination, etc. Other preprocessing technologies can be implemented.

At 540, an interactive processing and/or behavior analysis is performed. For example, the interactive processing and/or the behavior analysis can be determined based at least in part on the first gesture. The obtaining of the interactive processing and/or the behavior analysis can comprise the terminal or the server determining the interactive processing and/or the behavior analysis. In some embodiments, the interactive processing and/or the behavior analysis is determined based at least on the first gesture, and a service scenario corresponding to the first image. The interactive processing and/or the behavior analysis can be obtained by performing a look up against a mapping of gestures and service scenarios to find the interactive processing and/or the behavior analysis that corresponds to the first gesture in the context of the service scenario corresponding to the first image. The interactive processing and/or the behavior analysis can correspond to a single operation or a combination of two or more operations. In some embodiments, a multi-scenario application includes a plurality of service scenarios, and the first image is associated with at least one of the plurality of service scenarios. The service scenario corresponding to the first image can be obtained by performing a look up against a mapping of gestures and service scenarios to find the service scenario corresponding to the first image. According to some embodiments, in the event that an image is associated with a plurality of service scenarios, the service scenario corresponding to the first image can be obtained by performing a look up against a mapping of gestures, images, and the first image.

At 550, operating a device according to the interactive processing and/or the behavior analysis is performed. In some embodiments, the terminal operates according to the interactive processing and/or the behavior analysis. For example, the terminal the interactive processing and/or the behavior analysis.

In some embodiments, the interactive processing and/or the behavior analysis corresponds to configuring a user interface operation. For example, the interactive processing and/or the behavior analysis can include configuring a menu operation (e.g., opening a menu, closing a menu, opening a sub-menu of the current menu, selecting a menu option from the current menu, or other such operation). Accordingly, in connection with performing the interactive processing and/or the behavior analysis, various operations can be performed, including opening a menu, rendering a menu, and displaying the menu to the user. In some embodiments, the menu is displayed to the user using a VR display component. In some embodiments, the menu is displayed to the user using an AR or MR display component.

According to various embodiments, the interactive processing and/or the behavior analysis is not limited to menu operations. Various other operations can be performed (e.g., opening an application, switching to an application, obtaining specific information from the internet or a web service, etc.). For example, the interactive processing and/or the behavior analysis can be another operation, such as a speech prompt operation.

At 560, a display is rendered. For example, a rendering for display can be performed based on the operating a device according to the interactive processing and/or the behavior analysis. A menu can be rendered. Accordingly, in connection with performing a menu operation, various operations can be performed, including opening a menu, rendering a menu, and displaying the menu to the user. In some embodiments, the menu is displayed to the user using a VR display component. In some embodiments, the menu is displayed to the user using an AR or MR display component.

According to various embodiments, in the event there are multiple service scenarios, the operation executed on the basis of a gesture is made (e.g., selected) to match the current service scenario.

FIG. 6 is a functional diagram of a computer system for gesture-based interaction according to various embodiments of the present application.

Referring to FIG. 6, a computer system 600 for gesture-based interaction is provided. Computer system 600 can be implemented in connection with system 100 of FIG. 1. Computer system 600 can implement all or part of process 200 of FIG. 2, process 300 of FIG. 3, process 400 of FIG. 4, and/or process 500 of FIG. 5.

As will be apparent, other computer system architectures and configurations can be used to implement gesture-based interaction. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618).

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data, and objects used by the processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown). The memory can be a non-transitory computer-readable storage medium.

A removable mass storage device 612 provides additional data storage capacity for the computer system 600, and is coupled either bi-directionally (read/write) or uni-directionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storage device 612 and fixed mass storage 620 generally store additional programming instructions, data, and the like that typically are not in active use by the processor 602. It will be appreciated that the information retained within mass storage device 612 and fixed mass storage 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

The modules described as separate components may or may not be physically separate, and components displayed as modules may or may not be physical modules. They can be located in one place, or they can be distributed across multiple network modules. The embodiment schemes of the present embodiments can be realized by selecting part or all of the modules in accordance with actual need.

Furthermore, the functional modules in the various embodiments of the present invention can be integrated into one processor, or each module can have an independent physical existence, or two or more modules can be integrated into a single module. The aforesaid integrated modules can take the form of hardware, or they can take the form of hardware combined with software function modules.

Various embodiments provide a gesture-based interactive means based on the same technical concept. The gesture-based interactive means can implement the gesture-based interactive process described in the aforesaid embodiments. For example, the gesture-based interactive means can be a means used in virtual reality, augmented reality, and/or mixed reality.

The gesture-based interactive means may include: a processor, memory, a display device.

The processor can be a general-purpose processor (e.g., a microprocessor or any conventional processor), a digital signal processor, a special-purpose integrated circuit, a field-programmable gate array or other programmable logic device, a discrete gate or transistor logic device, or a discrete hardware component. The memory specifically can include internal memory and/or external memory, e.g., random access memory, flash memory, read only memory, programmable read only memory or electrically erasable programmable memory, registers, and other mature storage media in the art.

The processor has data connections with various other modules. For example, it can conduct data communications based on bus architecture. The bus architecture can include any quantity of interactive buses and bridges that specifically link together one or more processors represented by the processor with the various circuits of memory represented by memory. The bus architecture can further link together various kinds of other circuits such as peripheral equipment, voltage stabilizers, and power management circuits. All of these are well known in the art. Therefore, this document will not describe them further. The bus interface provides an interface. The processor is responsible for managing the bus architecture and general processing. The memory can store the data used by the processor when executing operations.

The process disclosed by embodiments of the present application can be applied in the processor or implemented by the processor. In the course of implementation, each step in the process described by the embodiments above can be completed by an integrated logic circuit of hardware in the processor or by software commands. All the methods, steps, and logic diagrams disclosed in embodiments of the present application can be implemented or executed. In light of the steps of the methods disclosed by embodiments of the present application, execution is completed directly by being embodied as hardware processors or is completed by combining hardware and software modules in processors. Software modules can be located in random access memory, flash memory, read only memory, programmable read only memory or electrically erasable programmable memory, registers, and other mature storage media in the art.

Specifically, the processor, coupled with memory, is for reading computer program commands stored by memory and, in response, executing the operations below: displaying a first image with said display device, said first image comprising one or a combination of more than one of: a virtual reality image, an augmented reality image, a mixed reality image; acquiring a first gesture; determining a first operation corresponding to said first gesture under the service scenario corresponding to said first image; responding to said first operation. With regard to how the process described above is specifically implemented, one can refer to the description of the previous embodiments. It will not be discussed further here.

Each of the embodiments contained in this description is described in a progressive manner, the explanation of each embodiment focuses on areas of difference from the other embodiments, and the descriptions thereof may be mutually referenced for portions of each embodiment that are identical or similar.

The present application is described with reference to flowcharts and/or block diagrams based on methods, equipment (systems) and computer program products. Please note that each flowchart and/or block diagram within the flowcharts and/or block diagrams and combinations of flowcharts and/or block diagrams within the flowcharts and/or block diagrams can be realized by computer commands. One can provide these computer commands to a general-purpose computer, a specialized computer, an embedded processor, or the processor of other programmable data equipment so as to give rise to a machine, with the result that the commands executed through the computer or processor of other programmable data equipment give rise to a device that is used to realize the functions designated by one or more processes in a flowchart and/or one or more blocks in a block diagram.

These computer program commands can also be stored in computer-readable memory that guides the computer or other programmable data processing equipment to operate in a specified manner, so that the commands stored in this computer-readable memory give rise to a product that includes the command device, and this command device realizes the functions designated in one or more processes in a flowchart and/or one or more of the blocks in a block diagram.

These computer program commands can also be loaded onto a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flowchart and/or one or more blocks in a block diagram.

Although preferred embodiments of the present application have already been described, a person skilled in the art can make other modifications or revisions to these embodiments once they grasp the basic creative concept. Therefore, the attached claims are to be interpreted as including the preferred embodiments as well as all modifications and revisions falling within the scope of the present application.

Obviously, a person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
providing a first image, the first image comprising one or more of a virtual reality image, an augmented reality image, and a mixed reality image;
obtaining a first gesture;
obtaining a first operation based at least in part on the first gesture and a service scenario corresponding to the first image, the service scenario being a context in which the first gesture is input; and
operating a terminal according to the first operation.

2. The method of claim 1, wherein obtaining the first operation comprises determining the first operation based at least in part on the first gesture and the service scenario corresponding to the first image.

3. The method of claim 1, further comprising:
before determining the first operation:
obtaining an interaction model corresponding to the service scenario based at least in part on the service scenario in which the first gesture is input; and
determining the first operation corresponding to the first gesture based at least in part on the interaction model.

4. The method of claim 3, wherein the interaction model comprises a gesture classification model and a mapping of gesture types to operations, wherein the gesture classification model is used in connection with determining a corresponding gesture type based on the first gesture.

5. The method of claim 4, wherein determining the first operation corresponding to the first gesture comprises:
determining a gesture type associated with the first gesture under the service scenario based at least in part on the gesture classification model; and
determining the first operation based at least in part on the gesture type associated with the first gesture and on the mapping of gesture types to operations.

6. The method of claim 3, further comprising:
obtaining a gesture classification model corresponding to a user associated with the first gesture based at least in part on user information.

7. The method of claim 6, wherein the obtaining the gesture classification model corresponding to the user comprises:
obtaining a user identifier associated with the user;
obtaining the gesture classification model corresponding to the user identifier, wherein one user identifier uniquely corresponds to one gesture classification model; and
using user grouping information and said user information as a basis for determining a user group in which the corresponding user is located, acquiring the gesture classification model corresponding to the user group in which said corresponding user is located, wherein one user group among a plurality of user groups comprises one or more users and uniquely corresponds to one gesture classification model.

8. The method of claim 6, wherein the obtaining the gesture classification model corresponding to the user comprises:
determining a user group to which the user belongs based at least in part on grouping information and the user information; and
obtaining the gesture classification model corresponding to the user group, wherein one user group comprises one or more users, and one user group uniquely corresponds to one gesture classification model.

9. The method of claim 4, further comprising:
obtaining a second operation in response to obtaining a second gesture after obtaining the first gesture under the service scenario; and
updating the gesture classification model based at least in part on a relationship of the second operation to the first operation.

10. The method of claim 9, the updating of the gesture classification model comprises one or more of:
in the event that a target object of the first operation is the same as a target object of the second operation, and in the event that operation actions respectively corresponding to the first operation and the second operation are different, updating the gesture type associated with the first gesture in the gesture classification model; and
in the event that the target object of the second operation is a sub-target of the target object of the first operation, maintaining the gesture type associated with the first gesture in the gesture classification model as unchanged in response to the second gesture.

11. The method of claim 10, wherein:
in the event that the first operation corresponds to an operation for opening a first menu and the second operation corresponds to an operation for closing said first menu, updating the gesture classification model associated with the first gesture in the gesture classification model; or
in the event that the first operation corresponds to an operation for opening a second menu, and the second operation corresponds to an operation for selecting a menu option from the second menu, maintaining the gesture type associated with the first gesture in the gesture classification model as unchanged in response to obtaining the second gesture.

12. The method of claim 3, further comprising:
sending interactive operation information under the service scenario to a server, the interactive operation information under the service scenario comprising information associated with the first gesture and the first operation operated in response to the first gesture; and
receiving the interaction model that corresponds to the service scenario, wherein the received interaction model was updated by the server based at least in part on the interactive operation information under the service scenario that was sent to the server.

13. The method of claim 1, wherein the obtaining the first gesture comprises:
obtaining first gesture data from the first gesture, wherein the first gesture was made by at least one hand of a user;
recognizing one or more joints of the at least one hand based at least in part on the first gesture data; and
determining a gesture type associated with the first gesture based at least in part on the one or more recognized joints.

14. The method of claim 1, wherein the first gesture comprises:
a single-hand gesture or a two-hand combination gesture.

15. The method of claim 1, wherein the first operation comprises a user interface operation.

16. The method of claim 15, wherein the user interface operation comprises a menu operation.

17. The method of claim 1, wherein the service scenario comprises:
a virtual reality (VR) service scenario; or
an augmented reality (AR) service scenario; or
a mixed reality (MR) service scenario.

18. (canceled)

19. (canceled)

20. (canceled)

21. (canceled)

22. (canceled)

23. (canceled)

24. (canceled)

25. (canceled)

26. (canceled)

27. A device, comprising:
one or more processors configured to:
provide a first image, the first image comprising one or more of a virtual reality image, an augmented reality image, and a mixed reality image;
obtain a first gesture;
obtain a first operation based at least in part on the first gesture and a service scenario corresponding to the first image, the service scenario being a context in which the first gesture is input; and
operate the device according to the first operation; and
one or more memories coupled to the one or more processors, configured to provide the one or more processors with instructions.

28. A device, comprising:
one or more processors configured to:
obtain a first gesture under a virtual reality scenario, an augmented reality scenario, or a mixed reality scenario;
determine whether the first gesture satisfies one or more conditions; and
in the event that the first gesture is determined to satisfy the one or more conditions, control data output, the data output comprising: one or a combination of audio data, image data, video data; and
one or more memories coupled to the one or more processors, configured to provide the one or more processors with instructions.

29. A device, comprising:
one or more processors configured to:
provide a first image, wherein the first image comprises a first object and a second object, and at least one of the first object and the second object being: a virtual reality object, an augmented reality object, or a mixed reality object;
obtain information associated with a first gesture, wherein the information associated with the first gesture is associated with the first object; and
process the second object based at least in part on a first operation corresponding to the first gesture; and
one or more memories coupled to the one or more processors, configured to provide the one or more processors with instructions.

30. (canceled)

31. (canceled)

32. (canceled)

33. (canceled)

34. A computer program product, the computer program product being embodied in a non-transitory computer readable storage medium and comprising computer instructions for:
obtaining interactive operation information that was sent by a terminal, the interactive operation information comprising gesture information and an operation that was executed based at least in part on the gesture information;
updating, based at least in part on the interactive operation information and a service scenario associated with the interactive operation information, an interaction model corresponding to the service scenario, wherein the interaction model is used in connection with determining a corresponding operation based on gesture;
storing the updated interaction model; and
communicating the updated interaction model to the terminal.
